(19) United States
(12) Patent Application Publication
(10) Pub. No.: US 2016/0244064 A1
(43) Pub. Date: Aug. 25, 2016

(54) HYBRID VEHICLE, CONTROLLER FOR HYBRID VEHICLE, AND CONTROL METHOD FOR HYBRID VEHICLE FOR REDUCING THE COMPRESSION RATIO AT START-UP OF THE ENGINE ACCORDING A BATTERY LEVEL

(71) Applicant: TOYOTA JIDOSHA KABUSHIKI KAISHA, Toyota-shi, Aichi-ken (JP)

(72) Inventors: Ryuta TERAYA, Okazaki-shi (JP); Yoshikazu ASAMI, Gotenba-shi (JP); Toshikazu KATO, Toyota-shi (JP)

(73) Assignee: TOYOTA JIDOSHA KABUSHIKI KAISHA, Toyota-shi, Aichi-ken (JP)

(21) Appl. No.: 15/026,281

(22) PCT Filed: Sep. 26, 2014
(86) PCT No.: PCT/IB2014/001929

§ 371 Date: Mar. 31, 2016

(30) Foreign Application Priority Data
Oct. 1, 2013 (JP) 2013-206373

(51) Int. Cl. B60W 30/192; B60W 10/06; B60W 20/00; B60W 30/20; F02D 29/02; F02D 13/02

(52) U.S. Cl. CPC B60W 30/192; F02D 29/02; F02D 13/0226; B60W 20/00; B60W 30/20; B60W 10/06; Y10S 903/905

(57) ABSTRACT

A hybrid vehicle includes an internal combustion engine, a rotary electric machine, an electrical storage device, and a controller. The internal combustion engine includes a variable valve actuating device configured to change an operation characteristic of an intake valve. The rotary electric machine is configured to start up the internal combustion engine. The electrical storage device is configured to store electric power for driving the rotary electric machine. The controller is configured to control the variable valve actuating device such that at least one of a valve lift of the intake valve and a valve operating angle of the intake valve at start-up of the internal combustion engine when performance of the electrical storage device is in a second state is smaller than the corresponding at least one of the valve lift of the intake valve and the valve operating angle of the intake valve at start-up of the internal combustion engine when the performance of the electrical storage device is a first state. The performance of the electrical storage device in the second state is more limited than the performance of the electrical storage device in the first state.

### CROSS-REFERENCE TO RELATED APPLICATIONS

This application is a national phase application of International Application No. PCT/IB2014/001929, filed Sep. 26, 2014, and claims the priority of Japanese Application No. 2013-206373, filed Oct. 1, 2013, the content of both of which is incorporated herein by reference.

### BACKGROUND OF THE INVENTION

1. Field of the Invention

The invention relates to a hybrid vehicle, a controller for a hybrid vehicle, and a control method for a hybrid vehicle and, more particularly, to a hybrid vehicle that includes an internal combustion engine including a variable valve actuating device for changing the operation characteristic of an intake valve, a controller for the hybrid vehicle, and a control method for the hybrid vehicle.

2. Description of Related Art

There is known an internal combustion engine including a variable valve actuating device that is able to change the operation characteristic of an intake valve. There is also known a variable valve actuating device that is able to change at least one of the valve lift and valve operating angle of an intake valve as such a variable valve actuating device (see Japanese Patent Application Publication No. 2005-299594 (JP 2005-299594 A), Japanese Patent Application Publication No. 2000-34913 (JP 2000-34913 A), Japanese Patent Application Publication No. 2009-190525 (JP 2009-190525 A), Japanese Patent Application Publication No. 2004-183610 (JP 2004-183610 A), Japanese Patent Application Publication No. 2013-53610 (JP 2013-53610 A), Japanese Patent Application Publication No. 2008-25550 (JP 2008-25550 A), Japanese Patent Application Publication No. 2012-117376 (JP 2012-117376 A), Japanese Patent Application Publication No. 9-242519 (JP 9-242519 A), and the like).

For example, JP 2005-299594 A describes a variable valve actuating device that is able to change the valve lift and valve operating angle of each intake valve of an internal combustion engine. In this variable valve actuating device, when the engine is automatically stopped on the assumption that the engine is restarted in a relatively short time, the valve operating angle of each intake valve during engine stop is set to a maximum operating angle in order to fully obtain decompression. On the other hand, when the engine is manually stopped, a target valve operating angle during engine stop is set to a value smaller than that when the engine is automatically stopped in order to handle both high-temperature start-up and low-temperature start-up. In this way, the startability of the engine is given a higher priority.

### SUMMARY OF THE INVENTION

In a hybrid vehicle on which a driving electric motor is mounted in addition to an engine, start-up and stop of the engine are automatically controlled on the basis of a traveling state. Therefore, the process of starting up the internal combustion engine frequently occurs. Particularly, the inside of a vehicle cabin is quiet while the hybrid vehicle is travelling by using only the electric motor. Therefore, while the hybrid vehicle is traveling by using only the electric motor, vibrations and noise resulting from engine start-up are easily experienced by a user. Thus, the technique described in JP 2005-299594 A is useful for a hybrid vehicle in terms of suppressing vibrations at engine start-up.

However, in control over the characteristic of each intake valve according to JP 2005-299594 A, the operation characteristic of each intake valve for fully obtaining decompression is uniformly set when the engine is automatically stopped. Therefore, if there occurs a situation that cranking torque is not sufficiently obtained at engine start-up, there is a concern that the startability of the internal combustion engine deteriorates.

The invention is to control the operation characteristic of an intake valve at engine start-up so that vibrations are appropriately suppressed at start-up of an internal combustion engine and startability of the internal combustion engine is appropriately ensured.

A first aspect of the invention provides a hybrid vehicle. The hybrid vehicle includes an internal combustion engine, a rotary electric machine, an electrical storage device, and a controller. The internal combustion engine includes a variable valve actuating device configured to change an operation characteristic of an intake valve. The rotary electric machine is configured to start up the internal combustion engine. The electrical storage device is configured to store electric power for driving the rotary electric machine. The controller is configured to control the variable valve actuating device such that at least one of a valve lift of the intake valve and a valve operating angle of the intake valve at start-up of the internal combustion engine when performance of the electrical storage device is a second state is smaller than the corresponding at least one of the valve lift of the intake valve and the valve operating angle of the intake valve at start-up of the internal combustion engine when the performance of the electrical storage device is a first state. The performance of the electrical storage device in the second state is more limited than the performance of the electrical storage device in the first state.

In the above aspect, a maximum value of cranking torque that is outputtable by the rotary electric machine to an output shaft of the internal combustion engine when the performance of the electrical storage device is the second state may be smaller than a maximum value of the cranking torque that is outputtable by the rotary electric machine when the performance of the electrical storage device is the first state.

In the above aspect, the performance of the electrical storage device may be in the second state when the electrical storage device satisfies any one of the following conditions (a), (b), (c), and (d), (a) the absolute value of a charge power upper limit value of the electrical storage device is lower than a predetermined value, (b) the absolute value of a discharge power upper limit value of the electrical storage device is lower than a predetermined value, (c) an SOC of the electrical storage device falls outside a predetermined range, and (d) a temperature of the electrical storage device falls outside a predetermined range.

In the above aspect, the variable valve actuating device may be configured to change the operation characteristic of the intake valve to one of a first characteristic and a second characteristic. At least one of the valve lift of the intake valve and the valve operating angle of the intake valve in the second characteristic may be larger than the corresponding at least one of the valve lift of the intake valve and the valve operating angle of the intake valve in the first characteristic. When the performance of the electrical storage device is the second state, the controller may be configured to control the variable valve actuating device such that the operation characteristic of the intake valve at start-up of the internal combustion engine is set to the first characteristic. When the performance of the electrical storage device is the first state, the controller may be configured to control the variable valve actuating device such that the operation characteristic of the intake valve at start-up of the internal combustion engine is set to the second characteristic.

In the above aspect, the variable valve actuating device may be configured to change the operation characteristic of the intake valve to any one of a first characteristic, a second characteristic and a third characteristic. At least one of the valve lift of the intake valve and the valve operating angle of the intake valve in the second characteristic may be larger than the corresponding at least one of the valve lift of the intake valve and the valve operating angle of the intake valve in the first characteristic. At least one of the valve lift of the intake valve and the valve operating angle of the intake valve in the third characteristic may be larger than the corresponding at least one of the valve lift of the intake valve and the valve operating angle of the intake valve in the second characteristic. When the performance of the electrical storage device is the second state, the controller may be configured to control the variable valve actuating device such that the operation characteristic of the intake valve at start-up of the internal combustion engine is set to one of the first characteristic and the second characteristic. When the performance of the electrical storage device is the first state, the controller may be configured to control the variable valve actuating device such that the operation characteristic of the intake valve at start-up of the internal combustion engine is set to the third characteristic.

In the above aspect, when a process of stopping the internal combustion engine is executed, the controller may be configured to control the variable valve actuating device such that at least one of the valve lift of the intake valve and the valve operating angle of the intake valve when the performance of the electrical storage device is the second state is smaller than the corresponding at least one of the valve lift of the intake valve and the valve operating angle of the intake valve when the performance of the electrical storage device is the first state.

In the above aspect, when a process of starting up the internal combustion engine is executed, the controller may be configured to control the variable valve actuating device such that at least one of the valve lift of the intake valve and the valve operating angle of the intake valve when the performance of the electrical storage device is the second state is smaller than the corresponding at least one of the valve lift of the intake valve and the valve operating angle of the intake valve when the performance of the electrical storage device is the first state.

In the above aspect, when the internal combustion engine is in a warm state, the controller may be configured to control the variable valve actuating device such that at least one of the valve lift of the intake valve and the valve operating angle of the intake valve at start-up of the internal combustion engine when the performance of the electrical storage device is the second state is equal to the corresponding at least one of the valve lift of the intake valve and the valve operating angle of the intake valve at start-up of the internal combustion engine when the performance of the electrical storage device is the first state.

In the above aspect, when the internal combustion engine is in a cold state, the controller may be configured to control the variable valve actuating device such that at least one of the valve lift of the intake valve and the valve operating angle of the intake valve at start-up of the internal combustion engine when the performance of the electrical storage device is the second state is smaller than the corresponding at least one of the valve lift of the intake valve and the valve operating angle of the intake valve at start-up of the internal combustion engine when the performance of the electrical storage device is the first state.

In the above aspect, the hybrid vehicle may further include a power transmission gear. The rotary electric machine may be mechanically coupled to both an output shaft of the internal combustion engine and a drive shaft of the hybrid vehicle through the power transmission gear.

Another aspect of the invention provides a controller for a hybrid vehicle. The hybrid vehicle includes an internal combustion engine, a rotary electric machine, and an electrical storage device. The internal combustion engine includes a variable valve actuating device configured to change an operation characteristic of an intake valve. The rotary electric machine is configured to start up the internal combustion engine. The electrical storage device is configured to store electric power for driving the rotary electric machine. The controller includes first control means and second control means. The first control means is configured to start up the internal combustion engine. The second control means is configured to control the variable valve actuating device such that at least one of a valve lift of the intake valve and a valve operating angle of the intake valve at start-up of the internal combustion engine when performance of the electrical storage device is a second state is smaller than the corresponding at least one of the valve lift of the intake valve and the valve operating angle of the intake valve at start-up of the internal combustion engine when the performance of the electrical storage device is a first state. The performance of the electrical storage device in the second state is more limited than the performance of the electrical storage device in the first state.

Further another aspect of the invention provides a control method for a hybrid vehicle. The hybrid vehicle includes an internal combustion engine, a rotary electric machine, an electrical storage device, and a controller. The internal combustion engine includes a variable valve actuating device configured to change an operation characteristic of an intake valve. The rotary electric machine is configured to start up the internal combustion engine. The electrical storage device is configured to store electric power for driving the rotary electric machine. The control method includes: (A) starting up the internal combustion engine by the controller; and (B) controlling the variable valve actuating device by the controller such that at least one of a valve lift of the intake valve and a valve operating angle of the intake valve at start-up of the internal combustion engine when performance of the electrical storage device is a second state is smaller than the corresponding at least one of the valve lift of the intake valve and the valve operating angle of the intake valve at start-up of the internal combustion engine when the performance of the electrical storage device is a first state, the performance of the electrical storage device in the second state being more limited than the performance of the electrical storage device in the first state. The hybrid vehicle includes an internal combustion engine, a rotary electric machine, an electrical storage device, and a controller. The internal combustion engine includes a variable valve actuating device configured to change an operation characteristic of an intake valve. The rotary electric machine is configured to start up the internal combustion engine. The electrical storage device is configured to store electric power for driving the rotary electric machine.

According to the above aspect, it is possible to control the operation characteristic of the intake valve at engine start-up so that vibrations are appropriately suppressed at start-up of the internal combustion engine and startability of the internal combustion engine is appropriately ensured.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram that shows the overall configuration of a hybrid vehicle according to an embodiment of the invention;

FIG. 2 is a configuration view of an engine shown in FIG. 1;

FIG. 3 is a graph that shows the correlation between a crank angle and a valve displacement that is achieved by a VVL device;

FIG. 4 is a front view of the VVL device;

FIG. 5 is a perspective view that partially shows the VVL device shown in FIG. 4;

FIG. 6 is a conceptual view that illustrates an operation at the time when the valve lift and valve operating angle of each intake valve are large;

FIG. 7 is a conceptual view that illustrates an operation at the time when the valve lift and valve operating angle of each intake valve are small;

FIG. 8 is a transition diagram that illustrates intermittent operation control over the engine in the hybrid vehicle shown in FIG. 1;

FIG. 9 is a first conceptual graph for showing the performance characteristic of an electrical storage device;

FIG. 10 is a second conceptual graph for illustrating the performance characteristic of the electrical storage device;

FIG. 11 is a table that illustrates intake valve control in the hybrid vehicle according to the first embodiment;

FIG. 12 is a flowchart that illustrates the control structure of intake valve control in the hybrid vehicle according to the first embodiment;

FIG. 13 is a flowchart that illustrates the control structure of intake valve control in the hybrid vehicle according to an alternative embodiment to the first embodiment;

FIG. 14 is a flowchart that illustrates the control structure of intake valve control in the hybrid vehicle according to a second embodiment;

FIG. 15 is a flowchart that illustrates the control structure of intake valve control in the hybrid vehicle according to an alternative embodiment to the second embodiment;

FIG. 16 is a graph that shows the correlation between a crank angle and a valve displacement that is achieved by a VVL device that is able to change the operation characteristic of each intake valve in three steps;

FIG. 17 is a graph that shows an operating line of an engine including the VVL device having the operation characteristics shown in FIG. 16;

FIG. 18 is a flowchart that shows the control structure of intake valve control according to the first embodiment by applying a VVL device having the operation characteristics shown in FIG. 16;

FIG. 19 is a flowchart that shows the control structure of intake valve control according to the alternative embodiment to the first embodiment by applying the VVL device having the operation characteristics shown in FIG. 16;

FIG. 20 is a flowchart that shows the control structure of intake valve control according to the second embodiment by applying the VVL device having the operation characteristics shown in FIG. 16;

FIG. 21 is a flowchart that shows the control structure of intake valve control according to the alternative embodiment to the second embodiment by applying the VVL device having the operation characteristics shown in FIG. 16; and

FIG. 22 is a graph that shows the correlation between a crank angle and a valve displacement that is achieved by a VVL device that is able to change the operation characteristic of each intake valve in two steps.

### DETAILED DESCRIPTION OF EMBODIMENTS

Hereinafter, embodiments of the invention will be described in detail with reference to the accompanying drawings. The plurality of embodiments will be described below; however, appropriate combinations of the configurations described in the embodiments are expected at the time of filing. Like reference numerals denote the same or corresponding portions in the drawings, and the description thereof will not be repeated.

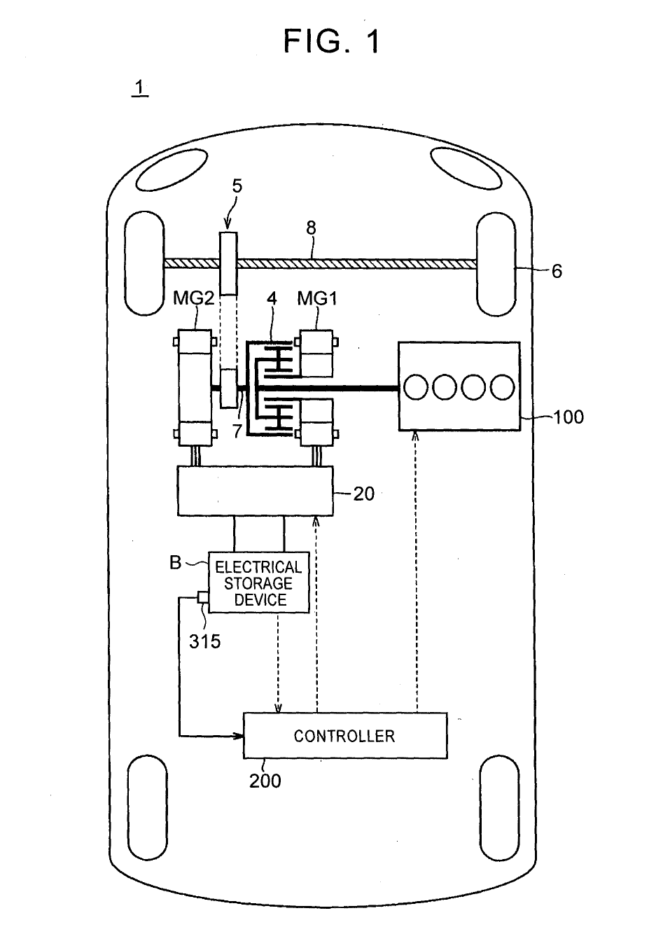

FIG. 1 is a block diagram that shows the overall configuration of a hybrid vehicle according to a first embodiment of the invention. As shown in FIG. 1, the hybrid vehicle 1 includes an engine 100, motor generators MG1, MG2, a power split device 4, a reduction gear 5, drive wheels 6, an electrical storage device B, a power control unit (PCU) 20, and a controller 200.

The engine 100 is, for example, an internal combustion engine, such as a gasoline engine and a diesel engine.

The power split device 4 is configured to be able to split power, which is generated by the engine 100, into a path toward a drive shaft 8 via an output shaft 7 and a path toward the motor generator MG1. The power split device 4 may be formed of a planetary gear train. The planetary gear train includes three rotary shafts, that is, a sun gear, a planetary gear and a ring gear. For example, the rotor of the motor generator MG1 has a hollow cylindrical shape, and a crankshaft of the engine 100 extends through the center of the hollow cylindrical rotor. Thus, the engine 100 and the motor generators MG1, MG2 are allowed to be mechanically connected to the power split device 4.

Specifically, the rotor of the motor generator MG1 is connected to the sun gear, the output shaft of the engine 100 is connected to the planetary gear, and the output shaft 7 is connected to the ring gear. The output shaft 7 is also connected to the rotary shaft of the motor generator MG2. The output shaft 7 is mechanically coupled to the drive shaft 8 via the reduction gear 5. The drive shaft 8 is used to rotationally drive the drive wheels 6. A reduction gear may be further assembled in between the rotary shaft of the motor generator MG2 and the output shaft 7.

Each of the motor generators MG1, MG2 is an alternating-current rotary electric machine, and is, for example, a three-phase alternating-current synchronous motor generator. The motor generator MG1 is configured to have both the function of an electric motor and the function of a generator. The motor generator MG1 operates as a generator that is driven by the engine 100, and also operates as an electric motor for starting up the engine 100.

Similarly, the motor generator MG2 generates vehicle driving force that is transmitted to the drive wheels 6 via the reduction gear 5 and the drive shaft 8. The motor generator MG2 is configured to have both the function of an electric motor and the function of a generator. The motor generator MG2 regenerates electric power by generating output torque in a direction opposite to the rotation direction of the drive wheels 6.

In the configuration example of FIG. 1, it is possible to apply rotational force (cranking torque) to the output shaft (crankshaft) of the engine 100 by the motor generator MG1. The motor generator MG1 uses the electrical storage device B as a power supply. That is, the motor generator MG1 is configured to be able to start up the engine 100. The motor generator MG1 is mechanically coupled to the drive shaft 8 of the hybrid vehicle 1 and the output shaft of the engine 100 via the power split device 4. The power split device 4 is an example of a power transmission gear.

The electrical storage device B is an electric power storage element configured to be rechargeable and dischargeable. The electrical storage device B is configured to include a secondary battery, such as a lithium ion battery, a nickel-metal hydride battery and a lead storage battery, or a cell of an electrical storage element, such as an electric double layer capacitor. A sensor 315 is provided at the electrical storage device B. The sensor 315 is used to detect the temperature, current and voltage of the electrical storage device B. Values detected by the sensor 315 are output to the controller 200. The controller 200 calculates a state of charge (hereinafter, also referred to as “SOC”) of the electrical storage device B on the basis of the values detected by the sensor 315.

The electrical storage device B is connected to the PCU 20 for driving the motor generators MG1, MG2. The electrical storage device B supplies the PCU 20 with electric power for generating the driving force of the hybrid vehicle 1. The electrical storage device B stores electric power generated by the motor generators MG1, MG2. The output of the electrical storage device B is, for example, 200 V.

The PCU 20 converts direct-current power, which is supplied from the electrical storage device B, to alternating-current power, and drives the motor generators MG1, MG2 by using the alternating-current power. The PCU 20 converts alternating-current power, generated by the motor generators MG1, MG2, to direct-current power, and charges the electrical storage device B with the direct-current power.

The controller 200 controls the outputs of the engine 100 and motor generators MG1, MG2 on the basis of the traveling state of the vehicle. Particularly, the controller 200 controls the driving mode of the hybrid vehicle 1 so as to combine an “EV mode” with an “HV mode”. In the “EV mode”, the vehicle travels by using the motor generator MG2 as the power source in a state where the engine 100 is stopped. In the “HV mode”, the vehicle travels in a state where the engine 100 is operated.

The controller 200 limits the charge/discharge electric power of the electrical storage device B on the basis of a state quantity of the electrical storage device B in order to suppress degradation of the electrical storage device B. Thus, the performance of the electrical storage device B is limited. The state quantity of the electrical storage device B is, for example, the temperature, SOC, and the like, of the electrical storage device B. Limiting the performance (charging and discharging) of the electrical storage device B will be described in detail later.

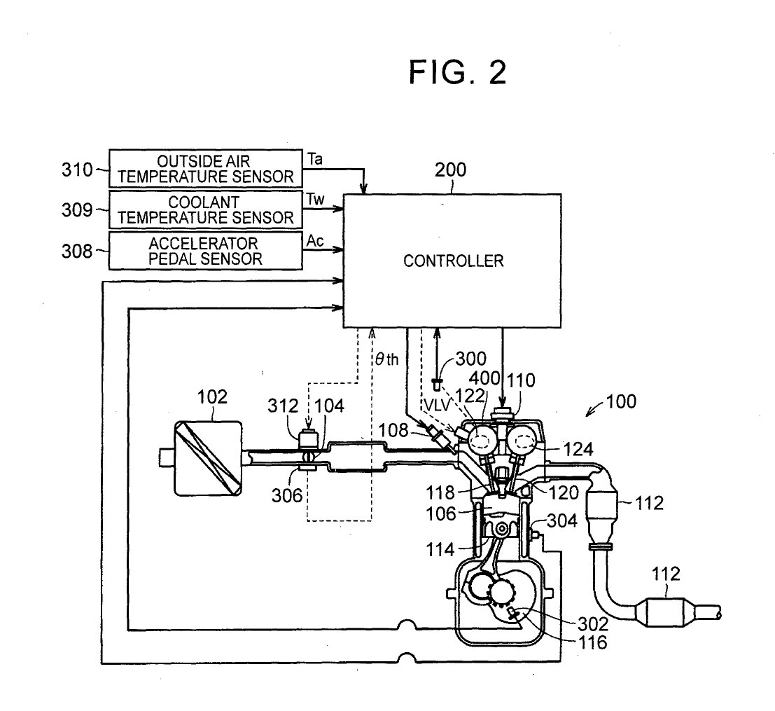

FIG. 2 is a view that shows the configuration of the engine 100 shown in FIG. 1. As shown in FIG. 2, air is taken into the engine 100 through an air cleaner 102. An intake air amount is adjusted by a throttle valve 104. The throttle valve 104 is an electrically controlled throttle valve that is driven by a throttle motor 312.

Each injector 108 injects fuel toward a corresponding intake port. Fuel is mixed with air in the intake port. Air-fuel mixture is introduced into each cylinder 106 when a corresponding intake valve 118 opens.

Each injector 108 may be provided as a direct injection injector that directly injects fuel into the corresponding cylinder 106. Alternatively, both the port injection injector 108 and the direct injection injector 108 may be provided.

Air-fuel mixture in each cylinder 106 is ignited by a corresponding ignition plug 110 to combust. The combusted air-fuel mixture, that is, exhaust gas, is purified by a three-way catalyst 112, and is then emitted to the outside of the vehicle. A piston 114 is pushed downward by combustion of air-fuel mixture, and a crankshaft 116 rotates.

The intake valve 118 and an exhaust valve 120 are provided at the top portion of each cylinder 106. The amount of air that is introduced into each cylinder 106 and the timing of introduction are controlled by the corresponding intake valve 118. The amount of exhaust gas that is emitted from each cylinder 106 and the timing of emission are controlled by the corresponding exhaust valve 120. Each intake valve 118 is driven by a cam 122. Each exhaust valve 120 is driven by a cam 124.

As will be described in detail later, the valve lift and valve operating angle of each intake valve 118 are controlled by a variable valve lift (VVL) device 400. The valve lift and valve operating angle of each exhaust valve 120 may also be controlled. A variable valve timing (VVT) device that controls the open/close timing may be combined with the VVL device 400.

The controller 200 controls a throttle opening degree θth, an ignition timing, a fuel injection timing, a fuel injection amount, and the operating state (open/close timing, valve lift, valve operating angle, and the like) of each intake valve so that the engine 100 is placed in a desired operating state. Signals are input to the controller 200 from various sensors, that is, a cam angle sensor 300, a crank angle sensor 302, a knock sensor 304, a throttle opening degree sensor 306, an accelerator pedal sensor 308, a coolant temperature sensor 309 and an outside air temperature sensor 310.

The cam angle sensor 300 outputs a signal indicating a cam position. The crank angle sensor 302 outputs signals indicating the rotation speed of the crankshaft 116 (engine rotation speed) and the rotation angle of the crankshaft 116. The knock sensor 304 outputs a signal indicating the strength of vibrations of the engine 100. The throttle opening degree sensor 306 outputs a signal indicating the throttle opening degree θth. The coolant temperature sensor 309 detects a coolant temperature Tw of the engine 100. The outside air temperature sensor 310 detects an outside air temperature Ta around the hybrid vehicle 1. The detected coolant temperature Tw and the detected outside air temperature Ta are input to the controller 200. The accelerator pedal sensor 308 detects a driver's operation amount of an accelerator pedal, and outputs a signal Ac to the controller 200. The signal Ac indicates the detected operation amount. The controller 200 is able to calculate a required acceleration/deceleration on the basis of the signal Ac received from the accelerator pedal sensor 308. The required acceleration/deceleration is required by the driver.

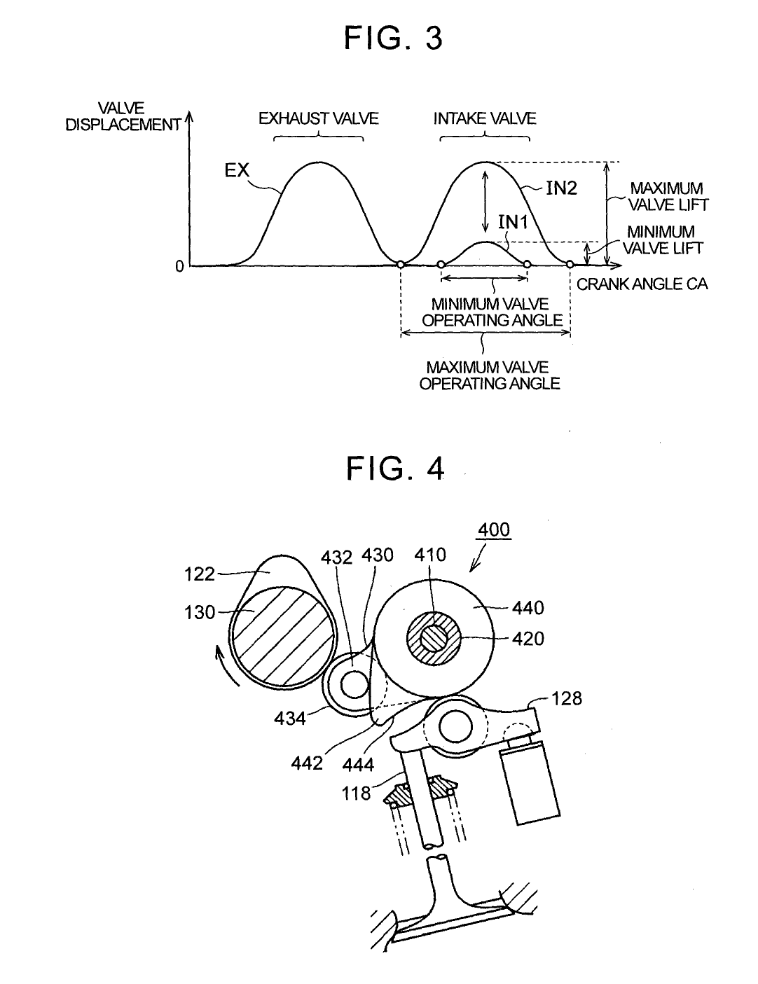

FIG. 3 is a graph that shows the correlation between a crank angle and a valve displacement that is achieved by the VVL device 400. As shown in FIG. 3, each exhaust valve 120 opens and closes in an exhaust stroke, and each intake valve 118 opens and closes in an intake stroke. The valve displacement of each exhaust valve 120 is indicated by a waveform EX. The valve displacement of each intake valve 118 is indicated by waveforms IN1, IN2.

The valve displacement is a displacement of each intake valve 118 from a state where the intake valve 118 is closed. The valve lift is a valve displacement at the time when the opening degree of each intake valve 118 has reached a peak. The valve operating angle is a crank angle of a period from when each intake valve 118 opens to when the intake valve 118 closes.

The operation characteristic of each intake valve 118 is changed by the VVL device 400 between the waveforms IN1, IN2. The waveform IN1 indicates the case where the valve lift and the valve operating angle are minimum. The waveform IN2 indicates the case where the valve lift and the valve operating angle are maximum. In the VVL device 400, the valve operating angle increases with an increase in the valve lift.

FIG. 4 is a front view of the VVL device 400 that is one example of a device that controls the valve lift and valve operating angle of each intake valve 118.

As shown in FIG. 4, the VVL device 400 includes a drive shaft 410, a support pipe 420, an input arm 430, and oscillation cams 440. The drive shaft 410 extends in one direction. The support pipe 420 covers the outer periphery of the drive shaft 410. The input arm 430 and the oscillation cams 440 are arranged in the axial direction of the drive shaft 410 on the outer periphery of the support pipe 420. An actuator (not shown) that linearly actuates the drive shaft 410 is connected to the distal end of the drive shaft 410.

The VVL device 400 includes the one input arm 430 in correspondence with the one cam 122 provided in each cylinder. The two oscillation cams 440 are provided on both sides of each input arm 430 in correspondence with the corresponding pair of intake valves 118 provided for each cylinder.

The support pipe 420 is formed in a hollow cylindrical shape, and is arranged parallel to a camshaft 130. The support pipe 420 is fixed to a cylinder head so as not to be moved in the axial direction or rotated.

The drive shaft 410 is inserted inside the support pipe 420 so as to be slidable in the axial direction. The input arm 430 and the two oscillation cams 440 are provided on the outer periphery of the support pipe 420 so as to be oscillatable about the axis of the drive shaft 410 and not to move in the axial direction.

The input arm 430 includes an arm portion 432 and a roller portion 434. The arm portion 432 protrudes in a direction away from the outer periphery of the support pipe 420. The roller portion 434 is rotatably connected to the distal end of the arm portion 432. The input arm 430 is provided such that the roller portion 434 is arranged at a position at which the roller portion 434 is able to contact the cam 122.

Each oscillation cam 440 has a substantially triangular nose portion 442 that protrudes in a direction away from the outer periphery of the support pipe 420. A concave cam face 444 is formed at one side of the nose portion 442. A roller rotatably attached to a rocker arm 128 is pressed against the cam face 444 by the urging force of a valve spring provided in the intake valve 118.

The input arm 430 and the oscillation cams 440 integrally oscillate about the axis of the drive shaft 410. Therefore, as the camshaft 130 rotates, the input arm 430 that is in contact with the cam 122 oscillates, and the oscillation cams 440 oscillate in interlocking with movement of the input arm 430. The movements of the oscillation cams 440 are transferred to the intake valves 118 via rocker arms 128, and the intake valves 118 are opened or closed.

The VVL device 400 further includes a device that changes a relative phase difference between the input arm 430 and each oscillation cam 440 around the axis of the support pipe 420. The valve lift and valve operating angle of each intake valve 118 are changed as needed by the device that changes the relative phase difference.

That is, when the relative phase difference between the input arm 430 and each oscillation cam 440 is increased, the oscillation angle of each rocker arm 128 is increased with respect to the oscillation angle of each of the input arm 430 and the oscillation cams 440, and the valve lift and valve operating angle of each intake valve 118 are increased.

When the relative phase difference between the input arm 430 and each oscillation cam 440 is reduced, the oscillation angle of each rocker arm 128 is reduced with respect to the oscillation angle of each of the input arm 430 and the oscillation cams 440, and the valve lift and valve operating angle of each intake valve 118 are reduced.

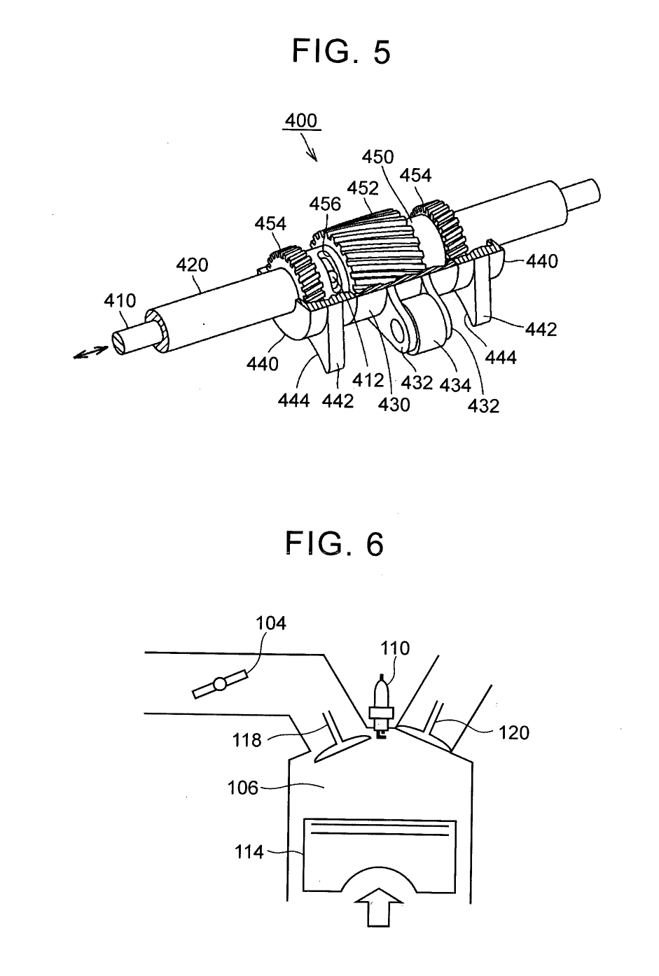

FIG. 5 is a perspective view that partially shows the VVL device 400. FIG. 5 shows a structure with part cut away so that the internal structure is clearly understood.

As shown in FIG. 5, a slider gear 450 is accommodated in a space defined between the outer periphery of the support pipe 420 and the set of input arm 430 and two oscillation cams 440. The slider gear 450 is supported on the support pipe 420 so as to be rotatable and slidable in the axial direction. The slider gear 450 is provided on the support pipe 420 so as to be oscillatable in the axial direction.

The slider gear 450 includes a helical gear 452. The helical gear 452 is located at the center portion of the slider gear 450 in the axial direction. Right-handed screw spiral helical splines are formed on the helical gear 452. The slider gear 450 includes helical gears 454. The helical gears 454 are respectively located on both sides of the helical gear 452. Left-handed screw spiral helical splines opposite to those of the helical gear 452 are formed on each of the helical gears 454.

On the other hand, helical splines corresponding to the helical gears 452, 454 are respectively formed on the inner peripheries of the input arm 430 and two oscillation cams 440. The inner peripheries of the input arm 430 and two oscillation cams 440 define a space in which the slider gear 450 is accommodated. That is, the right-handed spiral helical splines are formed on the input arm 430, and the helical splines are in mesh with the helical gear 452. The left-handed spiral helical splines are formed on each of the oscillation cams 440, and the helical splines are in mesh with the corresponding helical gear 454.

An oblong hole 456 is formed in the slider gear 450. The oblong hole 456 is located between the helical gear 452 and one of the helical gears 454, and extends in the circumferential direction. Although not shown in the drawing, an oblong hole is formed in the support pipe 420, and the oblong hole extends in the axial direction so as to partially overlap with the oblong hole 456. A locking pin 412 is integrally provided in the drive shaft 410 inserted inside the support pipe 420. The locking pin 412 protrudes through the overlapped portions of these oblong hole 456 and oblong hole (not shown).

When the drive shaft 410 is moved in the axial direction by the actuator (not shown) coupled to the drive shaft 410, the slider gear 450 is pressed by the locking pin 412, and the helical gears 452, 454 move in the axial direction of the drive shaft 410 at the same time. When the helical gears 452, 454 are moved in this way, the input arm 430 and the oscillation cams 440 spline-engaged with these helical gears 452, 454 do not move in the axial direction. Therefore, the input arm 430 and the oscillation cams 440 pivot around the axis of the drive shaft 410 through meshing of the helical splines.

At this time, the helical splines respectively formed on the input arm 430 and each oscillation cam 440 have opposite orientations. Therefore, the pivot direction of the input arm 430 and the pivot direction of each oscillation cam 440 are opposite to each other. Thus, the relative phase difference between the input arm 430 and each oscillation cam 440 changes, with the result that the valve lift and valve operating angle of each intake valve 118 are changed as is already described.

The controller 200 controls the valve lift and valve operating angle of each intake valve 118 by adjusting an operation amount of the actuator that linearly moves the drive shaft 410. The actuator may be, for example, formed of an electric motor. In this case, the electric motor that constitutes the actuator generally receives electric power supplied from a battery (auxiliary battery) other than the electrical storage device B. Alternatively, the actuator may be configured to operate by hydraulic pressure. The hydraulic pressure is generated from an oil pump that is driven by the engine 100.

The VVL device is not limited to the type illustrated in FIG. 4 and FIG. 5. For example, a VVL device that electrically drives each valve, a VVL device that hydraulically drives each valve, or the like, may be used. That is, in the present embodiment, the mechanism of changing the operation characteristic (valve lift and valve operating angle) of each intake valve 118 is not specifically limited. A known mechanism may be employed as needed.

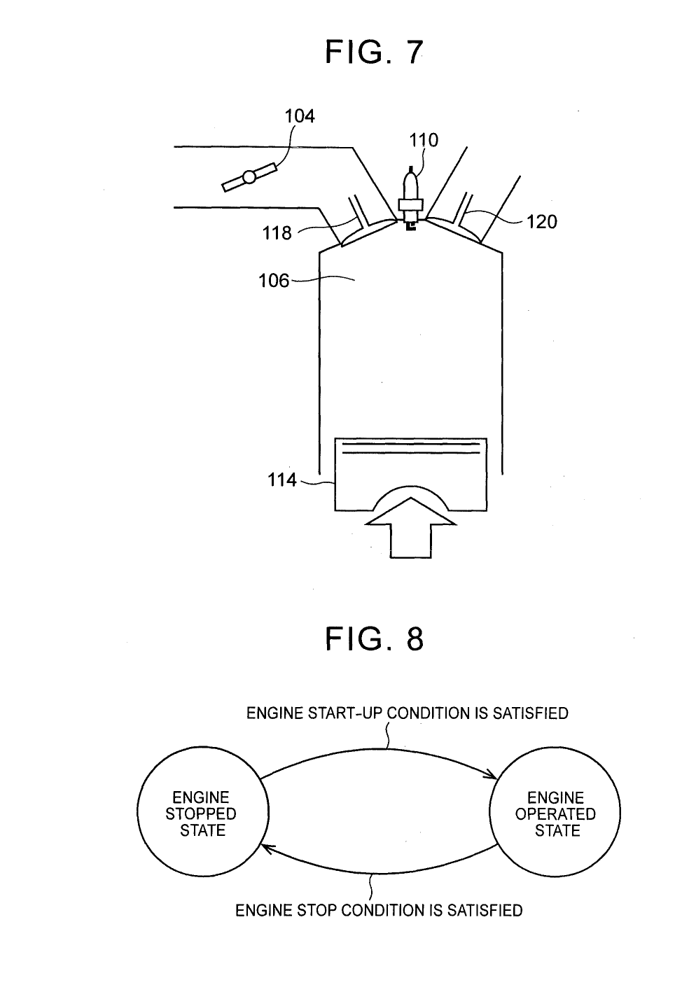

FIG. 6 is a view that illustrates an operation at the time when the valve lift and valve operating angle of each intake valve 118 are large. FIG. 7 is a view that illustrates an operation at the time when the valve lift and valve operating angle of each intake valve 118 are small.

As shown in FIG. 6 and FIG. 7, when the valve lift and valve operating angle of each intake valve 118 are large, because the close timing of each intake valve 118 delays, the engine 100 runs on the Atkinson cycle. That is, part of air taken into the cylinder 106 in the intake stroke is returned to the outside of the cylinder 106, so compression reaction that is a force for compressing air decreases in the compression stroke (decompression). Thus, it is possible to reduce vibrations at engine start-up. Thus, in the hybrid vehicle in which the number of engine start-up processes increases because the engine 100 is intermittently operated, it is desirable to increase the valve lift and valve operating angle of each intake valve 118 at engine start-up in order to obtain decompression. On the other hand, when the valve lift and valve operating angle of each intake valve 118 are increased, ignitability decreases because of a reduction in compression ratio. That is, engine startability relatively deteriorates.

On the other hand, when the valve lift and valve operating angle of each intake valve 118 are small, because the close timing of each intake valve 118 advances, the compression ratio increases. Therefore, ignitability improves at a low temperature, and the response of engine torque improves. Thus, it is possible to further reliably start up the engine if the valve lift and valve operating angle of each intake valve 118 are reduced at engine start-up. On the other hand, when the valve lift and valve operating angle of each intake valve 118 are reduced, compression reaction increases, so vibrations at engine start-up increases. That is, when the valve lift and valve operating angle of each intake valve 118 are small (FIG. 7), the decompression as illustrated in FIG. 6 reduces; however, the startability of the engine is high.

FIG. 8 is a transition diagram that illustrates intermittent operation control over the engine in the hybrid vehicle shown in FIG. 1.

As shown in FIG. 8, in the hybrid vehicle 1, start-up and stop of the engine 100 are basically automatically controlled on the basis of a traveling state. The controller 200 generates an engine start-up command when an engine start-up condition is satisfied in an engine stopped state. Thus, the engine start-up process is executed, with the result that the hybrid vehicle 1 shifts from the engine stopped state to an engine operated state.

On the other hand, the controller 200 generates an engine stop command when an engine stop condition is satisfied in the engine operated state. Thus, the engine stop process is executed, with the result that the hybrid vehicle 1 shifts from the engine operated state to the engine stopped state.

For example, in the hybrid vehicle 1, the engine start-up condition is determined on the basis of a comparison between an output parameter Pr and a threshold. The output parameter Pr quantitatively indicates an output (power or torque) that is required of the hybrid vehicle 1. That is, when the output parameter Pr exceeds a predetermined threshold Pth1, the engine start-up condition is satisfied.

For example, the output parameter Pr is a total required power Pt1 of the hybrid vehicle 1. The total required power Pt1 is allowed to be calculated from the sum of a required driving power Pr* and a required charge/discharge power Pchg (Pt1=Pr*+Pchg). The required driving power Pr* is expressed by the product of a required torque Tr* and the rotation speed of the drive shaft 8. The required torque Tr* reflects a driver's accelerator pedal operation amount. The required charge/discharge power Pchg is used to control the SOC of the electrical storage device B.

The required torque Tr* is set to a higher value as the accelerator pedal operation amount increases. In combination with the vehicle speed, it is desirable to set the required torque Tr* such that the required torque Tr* decreases as the vehicle speed increases for the same accelerator operation amount. It is applicable to previously create a map by reflecting these characteristics. The required torque Tr* is set on the basis of an accelerator pedal operation amount and the vehicle speed by using the map. Alternatively, it is also applicable to set the required torque Tr* additionally on the basis of a road surface state (road surface gradient, road surface friction coefficient, or the like) in accordance with a preset map or arithmetic expression.

The required charge/discharge power Pchg is set to zero in a CD mode in which the SOC is not kept (Pchg=0). On the other hand, in a CS mode, on the basis of the SOC, Pchg is set so as to be higher than 0 (charging) when the SOC has decreased, whereas Pchg is set so as to be lower than 0 (discharging) when the SOC has increased. That is, the required charge/discharge power Pchg is set so as to bring the SOC of the electrical storage device B close to a predetermined control target.

The controller 200 controls the outputs of the engine 100 and motor generators MG1, MG2 so that the total required power Pt1 is generated. For example, when the total required power Pt1 is small, for example, during low-speed traveling, the engine 100 is stopped. On the other hand, during acceleration based on accelerator pedal operation, the engine start-up condition is satisfied as a result of an increase in the total required power Pt1, with the result that the engine 100 is started up.

Alternatively, when warm-up of the three-way catalyst 112 is required, for example, at a low temperature of the engine 100 as well, the engine start-up condition is satisfied, and then the engine 100 is started up.

On the other hand, the engine stop condition is satisfied when the output parameter Pr (total required power Pt1) becomes lower than a predetermined threshold Pth2. It is desirable to prevent frequent change between the engine stopped state and the engine operated state by setting the threshold Pth1 of the engine start-up condition and the threshold Pth2 of the engine stop condition to different values (Pth1>Pth2).

In the case where the engine is started up in order to warm up the three-way catalyst 112, and the like, the engine stop condition is satisfied when a catalyst temperature or engine coolant temperature (coolant temperature sensor 309) becomes higher than a predetermined temperature. When vehicle operation is stopped in response to user's key switch operation (for example, when an IG switch is turned off) as well, the engine stop condition is satisfied.

The output parameter Pr for determining whether to operate or stop the engine 100 may be other than the total required power Pt1. For example, a required torque or required acceleration that is calculated so as to reflect at least an accelerator pedal operation amount, or an accelerator pedal operation amount itself may be used as the output parameter Pr.

In the engine start-up process for starting up the engine 100 in a stopped state, the engine 100 is cranked by the motor generator MG1 as shown in FIG. 1. Thus, when the engine start-up process is executed during stop or positive rotation of the motor generator MG1, the engine 100 is cranked by positive torque that is output from the motor generator MG1 as a result of a discharge of the electrical storage device B. In contrast, when the engine start-up process is executed during negative rotation of the motor generator MG1, the engine 100 is cranked by negative torque that is output from the motor generator MG1 as a result of a charge of the electrical storage device B.

In this way, the motor generator MG1 generates cranking torque at engine start-up as a result of a charge/discharge of the electrical storage device B. Thus, when the performance (charge/discharge) of the electrical storage device B is limited, the magnitude (absolute value) of cranking torque is also limited.

Generally, by setting a discharge power upper limit value Wout and a charge power upper limit value Win as limiting values for limiting charge/discharge of the electrical storage device B, the performance of the electrical storage device B is limited.

The discharge power upper limit value Wout indicates an upper limit value of discharge power, and is set such that Wout is higher than or equal to 0. When Wout is equal to 0, it means that a discharge of the electrical storage device B is prohibited. Similarly, the charge power upper limit value Win indicates an upper limit value of charge power, and is set such that Win is lower than or equal to 0. When the charge power upper limit value Win is set such that Win is equal to 0, it means that a charge of the electrical storage device B is prohibited.

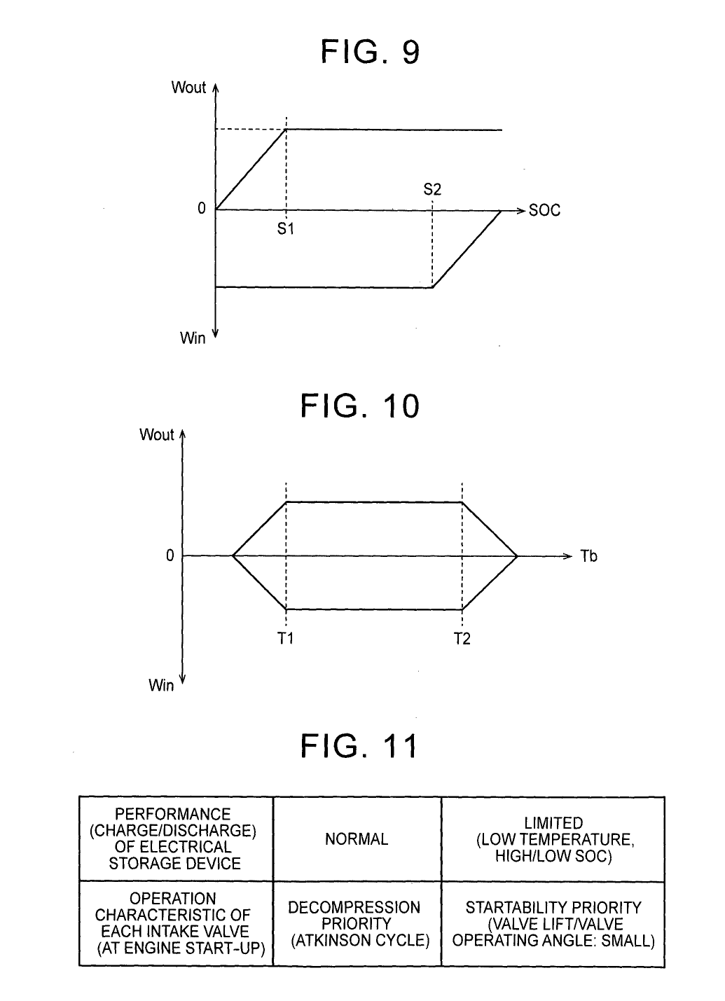

FIG. 9 and FIG. 10 are conceptual views for illustrating performance limits of the electrical storage device B. FIG. 9 shows the limits of electric power upper limit values Wout, Win for the SOC of the electrical storage device B. FIG. 10 shows the limits of electric power upper limit values Wout, Win for the temperature Tb of the electrical storage device B.

As shown in FIG. 9, in a low SOC region (SOC<S1), in order to limit a discharge of the electrical storage device B, the discharge power upper limit value Wout is set so as to be lower than the region expressed by SOC≧S1. Similarly, in a high SOC region (SOC>S2), in order to limit a charge of the electrical storage device B, the charge power upper limit value Win is set so as to be lower in absolute value than the region expressed by SOC≦S2.

As shown in FIG. 10, particularly, when the electrical storage device B is formed of a secondary battery, the power upper limit values Wout, Win are limited because of an increase in internal resistance at a low temperature and at a high temperature. For example, on the basis of the temperature Tb of the electrical storage device B, in a low-temperature region (Tb<T1) and in a high-temperature region (Tb>T2), the discharge power upper limit value Wout and the charge power upper limit value Win are limited as compared to an ordinary-temperature region (T1≦Tb≦T2).

In this way, the performance of the electrical storage device B is limited on the basis of the SOC and/or temperature Tb of the electrical storage device B, a charge/discharge power of the electrical storage device B decreases. Each of torque command values of the motor generators MG1, MG2 is limited so that the sum of input/output powers (Torque×Rotation speed) of each of the motor generators MG1, MG2 falls within the range of Win to Wout for protecting the electrical storage device B.

Thus, when the performance of the electrical storage device B is limited at start-up of the engine 100, the maximum value (absolute value) of cranking torque that is outputtable by the motor generator MG1 decreases. When the intake valve operation characteristic (that is, the valve lift and the valve operating angle are large) to which the Atkinson cycle is applied as described above is applied at the time when cranking torque decreases, there is a concern that the engine startability decreases.

As shown in FIG. 11, in the hybrid vehicle according to the present embodiment, the operation characteristic of each intake valve 118 at start-up of the engine 100 is set on the basis of the performance of the electrical storage device B. Specifically, when the performance of the electrical storage device B is normal, for example, when the absolute values of Win, Wout that are set in accordance with FIG. 9 and FIG. 10 are larger than a predetermined determination value, it is possible to ensure cranking torque by the motor generator MG1, so the operation characteristic of each intake valve 118 is set so as to apply the Atkinson cycle by giving a higher priority to decompression.

On the other hand, when the performance of the electrical storage device B is limited, for example, when the absolute values of Win, Wout are smaller than the above-described determination value, cranking torque that is outputtable by the motor generator MG1 decreases, so the operation characteristic of each intake valve 118 is set by giving a higher priority to the engine startability. That is, the VVL device 400 is controlled such that the valve lift and valve operating angle of each intake valve 118 at start-up of the engine 100 when the performance of the electrical storage device B is limited are smaller than the valve lift and valve operating angle of each intake valve 118 at start-up of the engine 100 when the performance of the electrical storage device B is normal.

In the present embodiment, because the charge/discharge power upper limit values Wout, Win of the electrical storage device B are introduced as limiting values, it is possible to determine the degree of limitation of the performance of the electrical storage device B by Win, Wout in an integrated manner as described above. That is, it is possible to determine whether the performance of the electrical storage device B is limited on the basis of a comparison between Win, Wout based on the current state of the electrical storage device B and the determination value.

Without using the power upper limit values Wout, Win or in addition to the power upper limit values Wout, Win, by using an SOC condition and/or a temperature condition, it may be determined whether the performance of the electrical storage device B is limited. For example, the SOC condition may be defined on the basis of whether the current SOC falls outside a normal SOC region (S1 to S2) shown in FIG. 9 (that is, the current SOC falls within a low SOC region or a high SOC region). The temperature condition may be applied on the basis of whether the temperature of the electrical storage device B falls outside a predetermined temperature region (T1 to T2) shown in FIG. 9 (that is, the temperature of the electrical storage device B falls within a low-temperature region or a high-temperature region). Alternatively, the temperature condition may be set such that only the state where the temperature of the electrical storage device B falls within the low-temperature region is determined to be the state where the performance of the electrical storage device B is limited.

Thus, when part or all of a power condition, defined by the power upper limit values Wout, Win, the SOC condition and the temperature condition are satisfied, it may be determined that the performance of the electrical storage device B is limited. In this way, in the present embodiment, the controller 200 is able to determine whether the performance (charge/discharge) of the electrical storage device B is in a more limited state (second state) than a normal state (first state) on the basis of the state of the electrical storage device B.

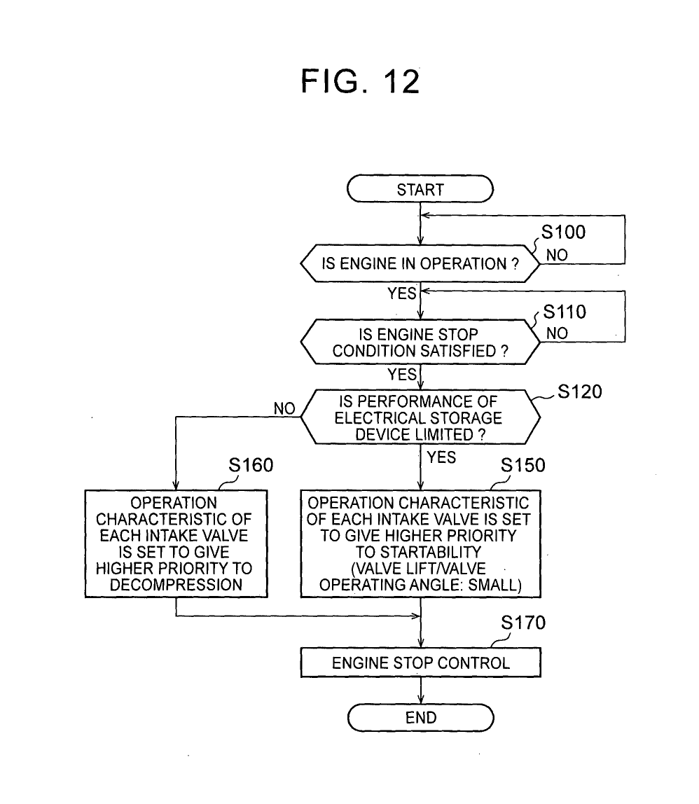

FIG. 12 is a flowchart that illustrates the control structure of intake valve control in the hybrid vehicle according to the first embodiment. The control process shown in FIG. 12 may be executed by the controller 200.

As shown in FIG. 12, the controller 200 executes the processes from step S110 during engine operation, that is, when affirmative determination is made in step S100. During engine operation (when affirmative determination is made in S100), the controller 200 determines whether the engine stop condition illustrated in FIG. 8 is satisfied (S110). In response to the fact that the engine stop condition is satisfied, the engine stop command is issued. Thus, the engine stop process is started. When the engine stop condition is not satisfied (when negative determination is made in S110), no engine stop command is issued, and the operated state of the engine 100 is continued.

When the engine stop command is issued (when affirmative determination is made in S110), the controller 200 determines whether the performance of the electrical storage device B is limited (S120). Typically, as described above, determination of step S120 may be carried out by comparing the power upper limit values Win, Wout based on the current state of the electrical storage device B with the predetermined value. Alternatively, determination of step S120 may be carried out on the basis of another state (Tb, SOC, or the like) of the electrical storage device B. Through the determination of step S120, it is determined whether it is in a state where cranking torque (absolute value) that is outputtable by the motor generator MG1 is small at the next engine start-up.

When the performance of the electrical storage device B is not limited (when negative determination is made in S120), the controller 200 sets the operation characteristic of each intake valve 118 such that decompression is given a higher priority (S160) in order to suppress vibrations at engine start-up as illustrated in FIG. 11. On the other hand, when the performance of the electrical storage device B is limited (when affirmative determination is made in S120), the controller 200 sets the operation characteristic of each intake valve 118 such that the engine startability is given a higher priority (S150) as illustrated in FIG. 11. That is, the valve lift and valve operating angle of each intake valve 118 in the operation characteristic of each intake valve 118, which is set in step S150, are set so as to be smaller than the valve lift and valve operating angle of each intake valve 118 in the operation characteristic of each intake valve 118, which is set in step S160.

The controller 200 executes control for stopping the engine 100 (S170). Thus, fuel injection from each injector 108 is stopped, and the torque of the motor generator MG1 is controlled so as to smoothly stop the engine 100. During engine stop control (S170), the controller 200 controls the VVL device 400 such that the operation characteristic of each intake valve 118, set in step S150 or step S160, is achieved.

Thus, during the stop process of the engine 100 based on the engine stop command, it is possible to appropriately set the operation characteristic (valve lift and valve operating angle) of each intake valve 118 in preparation for the next engine start-up. Specifically, on the basis of whether the performance of the electrical storage device B is limited, it is possible to give a higher priority to vibration suppression at engine start-up when cranking torque is ensured, and change the operation characteristic of each intake valve 118 so as to give a higher priority to the startability of the engine when cranking torque is limited. As described above, the time when the process of stopping the engine 100 is executed in the present embodiment not only indicates a period during which control for stopping the engine 100 (S170) is actually being executed but also can include a period from when the stop command is issued in response to the fact that the engine stop condition is satisfied (affirmative determination is made in S110) to when the engine stop control (S170) is executed.

Thus, with the hybrid vehicle according to the first embodiment, it is possible to control the operation characteristic of each intake valve 118 at engine start-up so that vibrations are suppressed at engine start-up and startability is ensured on the basis of the state of the electrical storage device B. The electrical storage device B is the power supply of the motor generator MG1 that generates cranking torque.

Generally, a period during which the VVL device 400 is able to change the operation characteristic of each intake valve 118 depends on the actuator. For example, in the case of an actuator that uses hydraulic pressure from an engine-driven oil pump as power, it is difficult to change the operation characteristic of each intake valve 118 during the engine start-up process. In the case of an actuator formed of an electric motor, in order to make it possible to change the operation characteristic of each intake valve 118 during the engine start-up process, the output of large torque from the actuator is required as compared to the case where the operation characteristic of each intake valve 118 is changed during rotation of the engine.

In other words, with the control that sets the operation characteristic of each intake valve 118 with the VVL device 400 during the engine stop process, illustrated in the first embodiment, the applicable mode of the VVL device 400 is wide.

On the other hand, if the period from engine stop to engine start-up extends, there is a possibility that the operation characteristic of each intake valve 118 at engine start-up is not the appropriate one that matches with the current state of the electrical storage device B because of a difference between the state of the electrical storage device B during the engine stop process and the state of the electrical storage device B at engine start-up.

Thus, in an alternative embodiment to the first embodiment, a control example in which the operation characteristic of each intake valve 118 is set during the engine start-up process will be described. The alternative embodiment to the first embodiment may be applied to a hybrid vehicle including the VVL device 400 having a mechanism (actuator) that is able to change the operation characteristic of each intake valve 118 during stop of the engine 100 or at a low rotation speed of the engine 100, as described above.

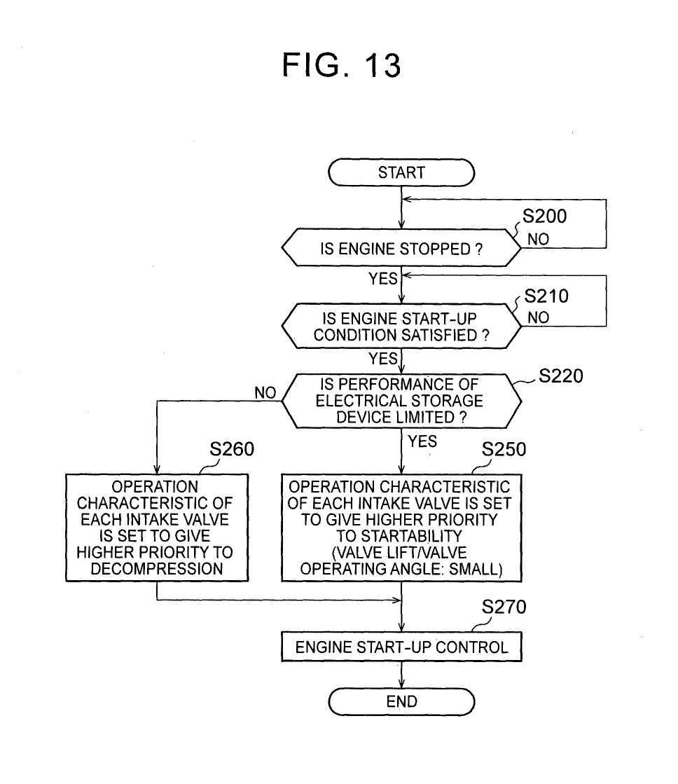

FIG. 13 is a flowchart that illustrates the control structure of intake valve control in the hybrid vehicle according to the alternative embodiment to the first embodiment. The control process shown in FIG. 13 may be executed by the controller 200.

As shown in FIG. 13, the controller 200 executes the processes from step S210 during engine stop, that is, when affirmative determination is made in step S200. During engine stop (when affirmative determination is made in S200), the controller 200 determines whether the engine start-up condition illustrated in FIG. 8 is satisfied (S210). In response to the fact that the engine start-up condition is satisfied, the engine start-up command is issued. Thus, the engine start-up process is started. When the engine start-up condition is not satisfied (when negative determination is made in S210), no engine start-up command is issued, and the stopped state of the engine 100 is continued.

When the engine start-up command is issued (when affirmative determination is made in S210), the controller 200 determines whether the performance of the electrical storage device B is limited (S220). Determination of step S220 is carried out as in the case of step S120.

When the performance of the electrical storage device B is not limited (when negative determination is made in S220), the controller 200 sets the operation characteristic of each intake valve 118 such that decompression is given a higher priority (S260) as in the case of step S160. On the other hand, when the performance of the electrical storage device B is limited (when affirmative determination is made in S220), the controller 200 sets the operation characteristic of each intake valve 118 such that the engine startability is given a higher priority (S250) as in the case of step S150. That is, the valve lift and valve operating angle of each intake valve 118 in the operation characteristic of each intake valve 118, which is set in step S250, are set so as to be smaller than the valve lift and valve operating angle of each intake valve 118 in the operation characteristic of each intake valve 118, which is set in step S260.

The controller 200 executes control for starting up the engine 100 (S270). Thus, in a state where the engine 100 is rotationally driven by cranking torque generated by the motor generator MG1, fuel injection from each injector 108 and ignition of each ignition plug 110 are started. During engine start-up control (S270), the controller 200 controls the VVL device 400 such that the operation characteristic of each intake valve 118, set in step S250 or step S260, is achieved. Setting of the operation characteristic of each intake valve 118 with the VVL device 400 needs to complete before the initial ignition timing (so-called initial combustion timing) of the engine 100.

Thus, during the start-up process of the engine 100 based on the engine start-up command, it is possible to appropriately set the operation characteristic (valve lift and valve operating angle) of each intake valve 118 as in the case of the first embodiment. Particularly, it is possible to set the operation characteristic (valve lift and valve operating angle) of each intake valve 118 on the basis of the state of the electrical storage device B at engine start-up. Therefore, when the period from engine stop to engine start-up extends as well, it is possible to control the operation characteristic of each intake valve 118 at start-up of the engine 100 so that vibrations are appropriately suppressed at engine start-up and startability is appropriately ensured. As described above, the time when the start-up process of the engine 100 is executed in the present embodiment not only indicates a period during which control for starting up the engine 100 (S270) is actually being executed but also can include a period from when the start-up command is issued in response to the fact that the engine start-up condition is satisfied (affirmative determination is made in S210) to when the engine start-up control (S270) is executed.

In the first embodiment, the operation characteristic of each intake valve 118 is uniformly set on the basis of whether the performance of the electrical storage device B, which is the power supply of the motor generator MG1 that generates cranking torque, is limited. However, when the engine 100 is once started up and is placed in a warm state, friction decreases, so the magnitude of cranking torque required to start up the engine decreases.

Particularly, in the hybrid vehicle 1, because the arrangement location of the engine 100 is different from the arrangement location of the electrical storage device B, the temperature of the electrical storage device B can decrease even when the engine 100 is in a warm state. In this way, it is conceivable that the startability of the engine may not deteriorate even when the performance of the electrical storage device B is limited.

Thus, in the second embodiment, an alternative embodiment in which the operation characteristic of each intake valve 118 is set on the basis of a combination of the state of the electrical storage device B and the state of the engine 100 will be described. The second embodiment differs from the first embodiment in the control structure of intake valve control (control process at engine stop). The other points including the configuration of the hybrid vehicle 1 are similar to those of the first embodiment, so the detailed description will not be repeated.

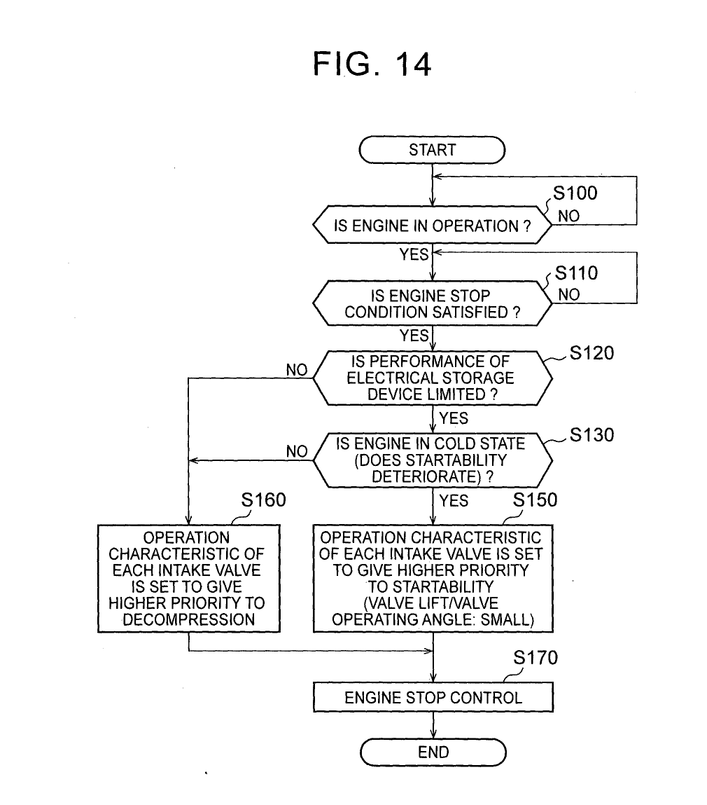

FIG. 14 is a flowchart that illustrates the control structure of intake valve control in the hybrid vehicle according to the second embodiment.

By comparing FIG. 14 with FIG. 12, in the engine stop process in the hybrid vehicle according to the second embodiment, by executing step S100 to step S120 similar to those of FIG. 12, when the performance of the electrical storage device B is limited (when affirmative determination is made in S120) at the time when the engine stop condition is satisfied, it is further determined whether the engine 100 is in a cold state where the startability of the engine 100 deteriorates (S130).

Determination of step S130 may be, for example, carried out on the basis of the outputs of the coolant temperature sensor 309 and outside air temperature sensor 310 shown in FIG. 2. For example, when the engine coolant temperature Tw is lower than a predetermined temperature (for example, 0° C.) and the outside air temperature is lower than a predetermined temperature (for example, −10° C.), affirmative determination is made in step S130.

In such a state, friction increases at start-up of the engine 100. Therefore, in a state where cranking torque (absolute value) that is outputtable by the motor generator MG1 decreases (when affirmative determination is made in S120), if the engine 100 is started up in a state where the valve lift and valve operating angle of each intake valve 118 are reduced by giving a higher priority to decompression, there is a concern that the engine startability decreases.

Thus, when the engine 100 is in a cold state where the startability of the engine 100 deteriorates (when affirmative determination is made in S130), the controller 200 sets the operation characteristic of each intake valve 118 such that the startability is given a higher priority in step S150. On the other hand, when negative determination is made in step S120 or step S130, the controller 200 sets the operation characteristic of each intake valve 118 such that decompression is given a higher priority in step S160. Thus, even when the performance of the electrical storage device B is limited (when affirmative determination is made in S120), when the engine 100 is not in a cold state where the startability of the engine 100 deteriorates (that is, in a warm state) (when negative determination is made in S130), the operation characteristic of each intake valve 118 is set so that vibrations at engine start-up are suppressed (S160). This is because friction of the engine 100 is reduced and, as a result, it is possible to normally start up the engine 100 by using the Atkinson cycle even when cranking torque (absolute value) is not large.

The subsequent process (S170) by the controller 200 is similar to FIG. 12, so the detailed description will not be repeated.

In this way, with the hybrid vehicle according to the second embodiment, it is possible to minimize the situation that the Atkinson cycle is not applied in order to give a higher priority to the engine startability. Thus, as in the case of the first embodiment, it is possible to control the operation characteristic of each intake valve 118 at engine start-up so that vibrations are appropriately suppressed at engine start-up and startability is appropriately ensured, and it is possible to further reduce the possibility that the user experiences a feeling of strangeness because of vibrations at engine start-up.

In an alternative embodiment to the second embodiment, as in the case of the alternative embodiment to the first embodiment, a control example in which setting of the operation characteristic of each intake valve 118 according to the second embodiment is carried out during the engine start-up process will be described.

The alternative embodiment to the second embodiment differs from the alternative embodiment to the first embodiment in the control structure of intake valve control (the control process at engine start-up). The other points including the configuration of the hybrid vehicle 1 are similar to those of the first embodiment or the alternative embodiment to the first embodiment, so the detailed description will not be repeated.

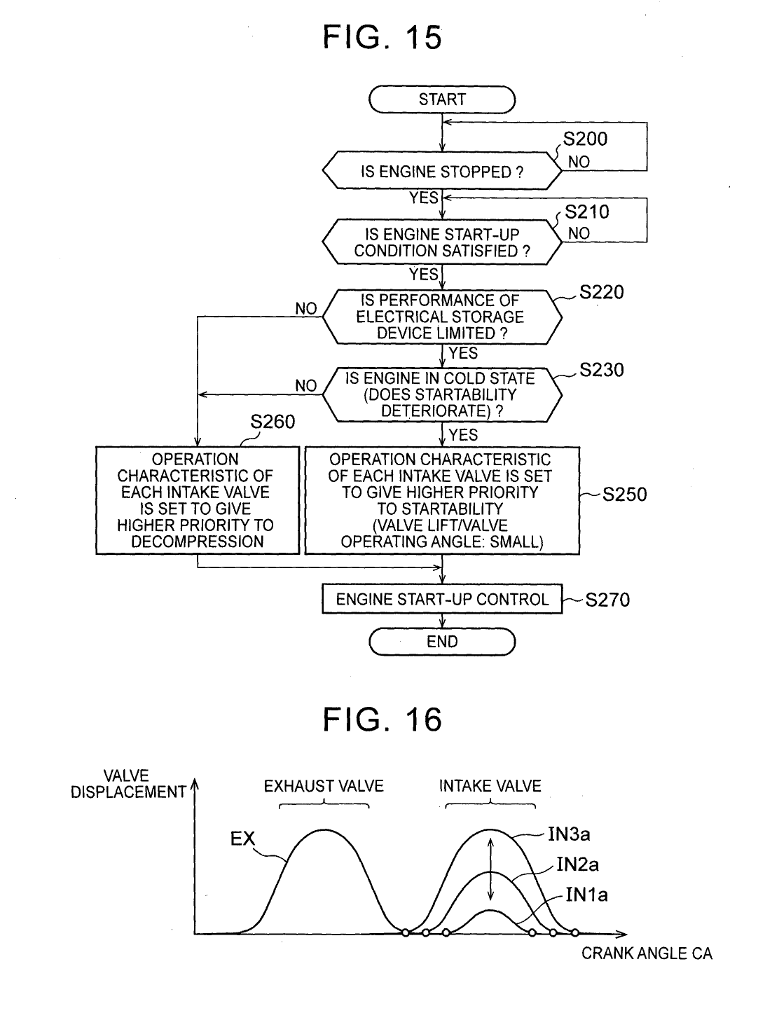

FIG. 15 is a flowchart that illustrates the control structure of intake valve control in the hybrid vehicle according to the alternative embodiment to the second embodiment.

By comparing FIG. 15 with FIG. 13, in the engine start-up process in the hybrid vehicle according to the alternative embodiment to the second embodiment, when the performance of the electrical storage device B is limited (when affirmative determination is made in S220) at the time when the engine start-up condition is satisfied (that is, when the engine start-up command is issued), it is further determined whether the engine 100 is in a cold state where the startability of the engine 100 deteriorates (S230). Determination of step S230 is carried out similarly to step S130 (FIG. 14).

When the engine 100 is in a cold state where the startability of the engine 100 deteriorates (when affirmative determination is made in S230), the controller 200 sets the operation characteristic of each intake valve 118 such that the startability is given a higher priority in step S250. On the other hand, when negative determination is made in step S220 or step S230, the controller 200 sets the operation characteristic of each intake valve 118 such that decompression is given a higher priority in step S260.

Thus, even when the performance of the electrical storage device B is limited (when affirmative determination is made in S220), when the engine 100 is not in a cold state where the startability of the engine 100 deteriorates (that is, in a warm state) (when negative determination is made in S230), the operation characteristic of each intake valve 118 may be set so that vibrations at engine start-up are suppressed as in the case of the second embodiment. The subsequent process (S270) by the controller 200 is similar to FIG. 13, so the detailed description will not be repeated.

In this way, with the hybrid vehicle according to the alternative embodiment to the second embodiment, it is possible to minimize the situation that the Atkinson cycle is not applied in order to give a higher priority to the engine startability as in the case of the second embodiment. Thus, as in the case of the second embodiment, it is possible to further reduce the possibility that the user experiences a feeling of strangeness because of vibrations at engine start-up.

In addition, as in the case of the alternative embodiment to the first embodiment, when the period from engine stop to engine start-up extends as well, it is possible to appropriately control the operation characteristic of each intake valve 118 at engine start-up.

In the above-described embodiments, the valve lift and valve operating angle of each intake valve 118 may be changed continuously (steplessly) or may be changed discretely (stepwisely).

FIG. 16 is a graph that shows the correlation between a crank angle and a valve displacement that is achieved by a VVL device 400A that is able to change the operation characteristic of each intake valve 118 in three steps. The VVL device 400A is able to change the operation characteristic to any one of first to third characteristics. The first characteristic is indicated by a waveform IN1a. The second characteristic is indicated by a waveform IN2a. The valve lift and the valve operating angle in the second characteristic are larger than the valve lift and the valve operating angle in the first characteristic. The third characteristic is indicated by a waveform IN3a. The valve lift and the valve operating angle in the third characteristic are larger than the valve lift and the valve operating angle in the second characteristic.

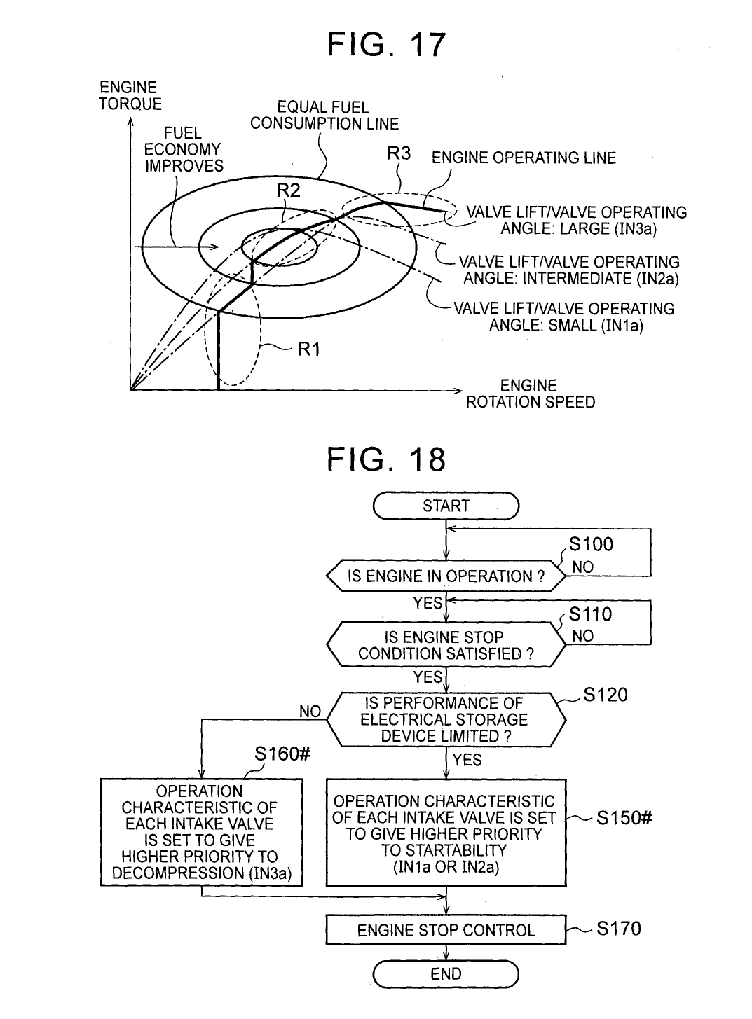

In FIG. 17, the abscissa axis represents engine rotation speed, and the ordinate axis represents engine torque. The alternate long and short dashed lines in FIG. 17 indicate torque characteristics corresponding to the first to third characteristics (IN1a to IN3a). The circles indicated by the continuous line in FIG. 17 indicate equal fuel consumption lines. Each equal fuel consumption line is a line connecting points at which a fuel consumption amount is equal. The fuel economy improves as approaching the center of the circles. The engine 100A is basically operated along the engine operating line indicated by the continuous line in FIG. 17.

In a low rotation speed region indicated by the region R1, it is important to reduce shock at engine start-up. In addition, introduction of exhaust gas recirculation (EGR) gas is stopped, and fuel economy is improved by using the Atkinson cycle. Thus, the third characteristic (IN3a) is selected as the operation characteristic of each intake valve 118 so that the valve lift and the valve operating angle increase. In an intermediate rotation speed region indicated by the region R2, fuel economy is improved by increasing the amount of introduction of EGR gas. Thus, the second characteristic (IN2a) is selected as the operation characteristic of each intake valve 118 so that the valve lift and the valve operating angle are intermediate.

That is, when the valve lift and valve operating angle of each intake valve 118 are large (third characteristic), improvement in fuel economy by using the Atkinson cycle is given a higher priority than improvement in fuel economy by introduction of EGR gas. On the other hand, when the intermediate valve lift and valve operating angle are selected (second characteristic), improvement in fuel economy by introduction of EGR gas is given a higher priority than improvement in fuel economy by using the Atkinson cycle.

In a high rotation speed region indicated by the region R3, a large amount of air is introduced into each cylinder by the inertia of intake air, and the output performance is improved by increasing an actual compression ratio. Thus, the third characteristic (IN3a) is selected as the operation characteristic of each intake valve 118 so that the valve lift and the valve operating angle increase.

When the engine 100A is operated at a high load in the low rotation speed region, when the engine 100A is started up at an extremely low temperature or when a catalyst is warmed up, the first characteristic (IN1a) is selected as the operation characteristic of each intake valve 118 so that the valve lift and the valve operating angle decrease. In this way, the valve lift and the valve operating angle are determined on the basis of the operating state of the engine 100A.

FIG. 18 to FIG. 21 show flowcharts that illustrate the control structures of intake valve control by applying the VVL device 400A having the operation characteristics shown in FIG. 16 according to the first embodiment, the alternative embodiment to the first embodiment, the second embodiment and the alternative embodiment to the second embodiment.

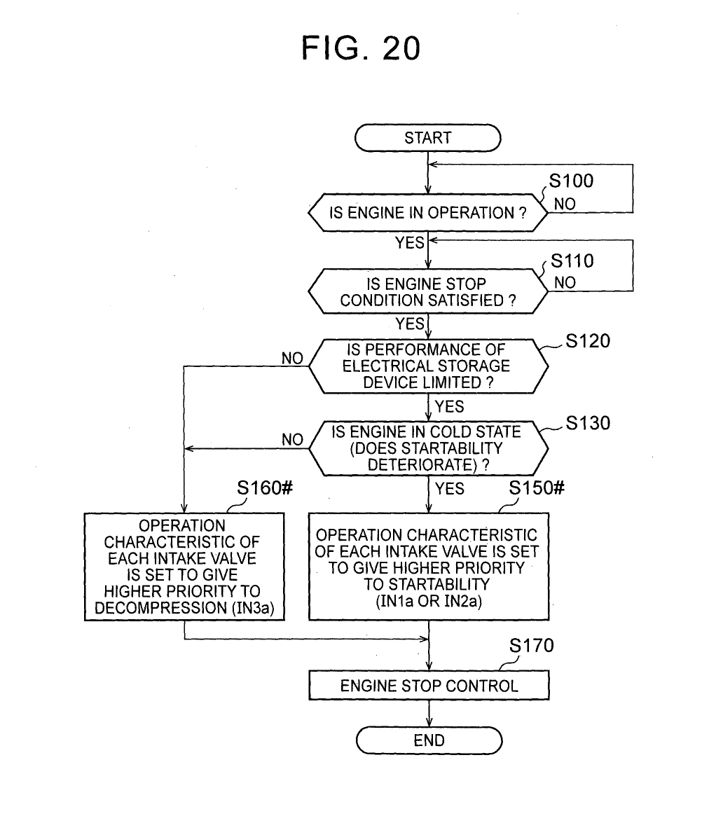

In each of FIG. 18 and FIG. 20, the VVL device 400A is controlled during the engine stop process such that the operation characteristic of each intake valve 118, set in step S150# or step S160# that is executed instead of step S150 or step S160, is achieved.

When the performance of the electrical storage device B is normal, the controller 200 sets the operation characteristic of each intake valve 118 to the third characteristic (IN3a) in step S160#. Thus, vibrations at engine start-up are suppressed by applying the Atkinson cycle. On the other hand, when the performance of the electrical storage device B is limited, the controller 200 sets the operation characteristic of each intake valve 118 to the first characteristic (IN1a) or the second characteristic (IN2a), preferably, the first characteristic (IN1a), in step S150#. Thus, the engine startability is increased.

The processes of step S100, step S110, step S120, step S170 shown in FIG. 18 and FIG. 20 are similar to those of FIG. 12 and FIG. 14, so the description will not be repeated.

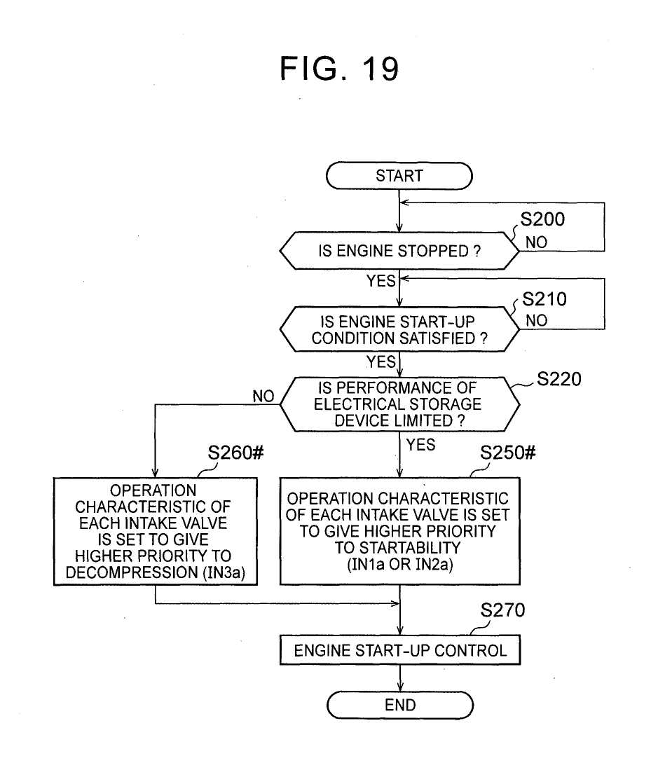

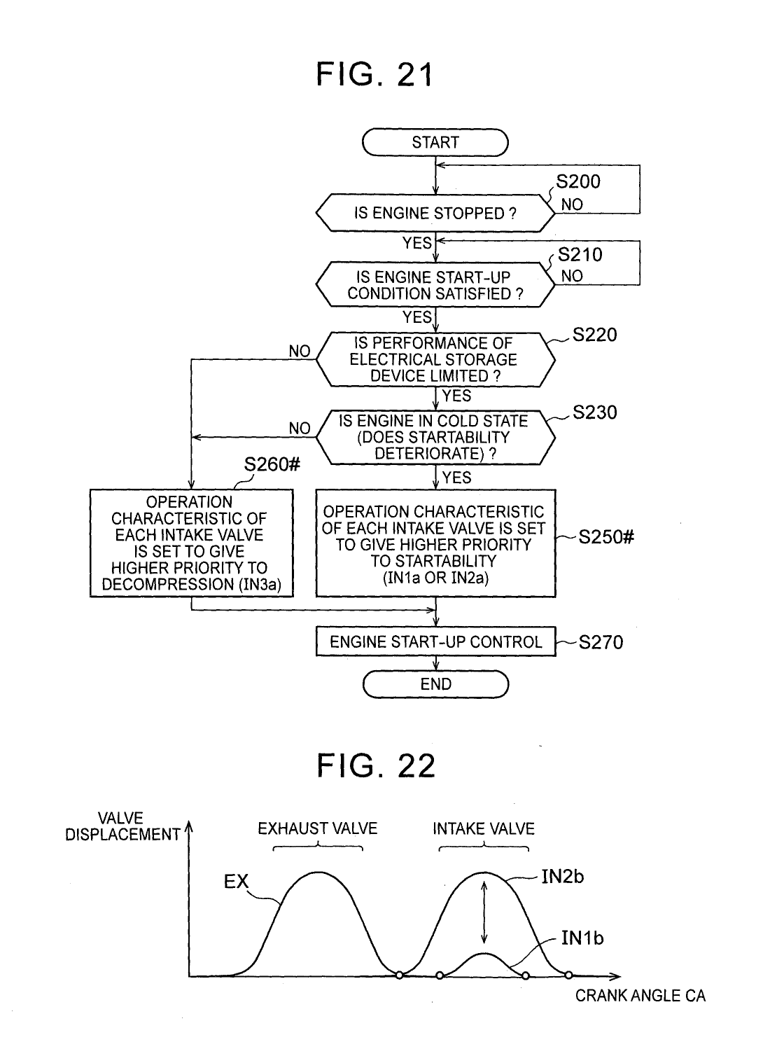

In each of FIG. 19 and FIG. 21, the VVL device 400A is controlled during the engine start-up process such that the operation characteristic of each intake valve 118, set in step S250# or step S260# that is executed instead of step S250 or step S260, is achieved.

When the performance of the electrical storage device B is normal, the controller 200 sets the operation characteristic of each intake valve 118 to the third characteristic (IN3a) in step S260#. Thus, vibrations at engine start-up are suppressed by applying the Atkinson cycle. On the other hand, when the performance of the electrical storage device B is limited, the controller 200 sets the operation characteristic of each intake valve 118 to the first characteristic (IN1a) or the second characteristic (IN2a), preferably, the first characteristic (IN1a), in step S250#. Thus, the engine startability is increased.

In this way, when the VVL device 400A is applied as well, it is possible to execute intake valve control according to the first embodiment, intake valve control according to the alternative embodiment to the first embodiment, intake valve control according to the second embodiment and intake valve control according to the alternative embodiment to the second embodiment in accordance with the flowcharts shown in FIG. 18 to FIG. 21.

With the configuration in which the VVL device 400A is applied, because the operation characteristic, that is, the valve lift and valve operating angle, of each intake valve 118 is limited to three characteristics, it is possible to reduce a time that is required to adapt control parameters for controlling the operating state of the engine 100 in comparison with the case where the valve lift and valve operating angle of each intake valve 118 continuously change. In addition, it is possible to reduce torque that is required of the actuator for changing the valve lift and valve operating angle of each intake valve 118, so it is possible to reduce the size and weight of the actuator. The manufacturing cost of the actuator can also be reduced.

FIG. 22 is a graph that shows the correlation between a crank angle and a valve displacement that is achieved by a VVL device 400B that is able to change the operation characteristic of each intake valve 118 in two steps. The VVL device 400B is able to change the operation characteristic to one of first and second characteristics. The first characteristic is indicated by a waveform IN1b. The second characteristic is indicated by a waveform IN2b. The valve lift and the valve operating angle in the second characteristic are larger than the valve lift and the valve operating angle in the first characteristic.

In this case, when the performance of the electrical storage device B is limited, the VVL device 400B is controlled such that the operation characteristic of each intake valve 118 is set to the first characteristic, whereas, when the performance of the electrical storage device B is not limited, the VVL device 400B is controlled such that the operation characteristic of each intake valve 118 is set to the second characteristic in order to give a higher priority to decompression.

With such a configuration, because the operation characteristic of the valve lift and valve operating angle of each intake valve 118 is limited to two characteristics, it is possible to further reduce a time that is required to adapt control parameters for controlling the operating state of the engine 100. It is also possible to further simplify the configuration of the actuator. The operation characteristic of the valve lift and valve operating angle of each intake valve 118 is not limited to the case where the operation characteristic is changed in two steps or in three steps. The operation characteristic may be changed in any number of steps larger than or equal to four steps.

In the above-described embodiments, the valve operating angle of each intake valve 118 is changed together with the valve lift of each intake valve 118. However, the invention is also applicable to a configuration that is able to change only the valve lift of each intake valve 118 or a configuration that is able to change only the valve operating angle of each intake valve 118. With the configuration that is able to change any one of the valve lift and valve operating angle of each intake valve 118 as well, it is possible to obtain similar advantageous effects to the case where it is possible to change both the valve lift and valve operating angle of each intake valve 118. The configuration that is able to change any one of the valve lift and valve operating angle of each intake valve 118 may be implemented by utilizing various known techniques.

In the above-described embodiments, the series-parallel hybrid vehicle is able to transmit the power of the engine 100 by distributing the power of the engine 100 to the drive wheels 6 and the motor generators MG1, MG2 by the power split device 4. The invention is also applicable to a hybrid vehicle of another type. That is, the invention is also applicable to, for example, a so-called series hybrid vehicle in which the engine 100 is only used to drive the motor generator MG1 and the driving force of the vehicle is generated by only the motor generator MG2, a hybrid vehicle in which only regenerative energy within kinetic energy generated by the engine 100 is recovered as electric energy, a motor-assist hybrid vehicle in which the engine is used as a main power source and a motor, where necessary, assists, or the like. The invention is also applicable to a hybrid vehicle that travels by using the power of only the engine while the motor is separated. That is, the technical idea of the invention is applicable common to a hybrid vehicle that includes an internal combustion engine including a variable valve actuating device for changing the operation characteristic of each intake valve. The technical idea is that the operation characteristic of each intake valve is changed on the basis of the state of the electrical storage device that is the power supply of the electric motor that generates cranking torque for the engine.

Alternatively, the application of the invention is not limited to the hybrid vehicle. The technical idea of the invention is also applicable to a vehicle in which only the engine is mounted as long as the vehicle is configured such that the engine is intermittently operated through so-called idle stop control, or the like. That is, at start-up of the engine including a variable valve actuating device for changing the operation characteristic of each intake valve, the operation characteristic of each intake valve may be changed on the basis of the state of the electrical storage device that is the power supply of the electric motor that generates cranking torque for the engine.

The embodiments described above are expected to be implemented in appropriate combinations. The embodiments described above should be regarded as only illustrative in every respect and not restrictive. The scope of the invention is defined by the appended claims rather than the description of the above embodiments. The scope of the invention is intended to encompass all modifications within the scope of the appended claims and equivalents thereof.

1. A hybrid vehicle comprising:
an internal combustion engine including a variable valve actuating device configured to change an operation characteristic of an intake valve;
a rotary electric machine configured to start up the internal combustion engine;
an electrical storage device configured to store electric power for driving the rotary electric machine; and
a controller configured to control the variable valve actuating device such that at least one of a valve lift of the intake valve and a valve operating angle of the intake valve at start-up of the internal combustion engine when performance of the electrical storage device is in a second state is smaller than the corresponding at least one of the valve lift of the intake valve and the valve operating angle of the intake valve at start-up of the internal combustion engine when the performance of the electrical storage device is in a first state, the performance of the electrical storage device in the second state being more limited than the performance of the electrical storage device in the first state, wherein
when a process of stopping the internal combustion engine is executed, the controller is configured to control the variable valve actuating device such that at least one of the valve lift of the intake valve and the valve operating angle of the intake valve when the performance of the electrical storage device is in the second state is smaller than the corresponding at least one of the valve lift of the intake valve and the valve operating angle of the intake valve when the performance of the electrical storage device is in the first state.

2. The hybrid vehicle according to claim 1, wherein
a maximum value of cranking torque that is outputtable by the rotary electric machine to an output shaft of the internal combustion engine when the performance of the electrical storage device is in the second state is smaller than a maximum value of the cranking torque that is outputtable by the rotary electric machine when the performance of the electrical storage device is in the first state.

3. The hybrid vehicle according to claim 1, wherein
the performance of the electrical storage device is in the second state when the electrical storage device satisfies any one of the following conditions (a), (b), (c), and (d),
(a) the absolute value of a charge power upper limit value of the electrical storage device is lower than a predetermined value,
(b) the absolute value of a discharge power upper limit value of the electrical storage device is lower than a predetermined value,
(c) an SOC of the electrical storage device falls outside a predetermined range, and
(d) a temperature of the electrical storage device falls outside a predetermined range.

4. The hybrid vehicle according to claim 1, wherein
the variable valve actuating device is configured to change the operation characteristic of the intake valve to one of a first characteristic and a second characteristic,
when the performance of the electrical storage device is in the second state, the controller is configured to control the variable valve actuating device such that the operation characteristic of the intake valve at start-up of the internal combustion engine is set to the first characteristic,
when the performance of the electrical storage device is in the first state, the controller is configured to control the variable valve actuating device such that the operation characteristic of the intake valve at start-up of the internal combustion engine is set to the second characteristic, and
at least one of the valve lift of the intake valve and the valve operating angle of the intake valve in the second characteristic is larger than the corresponding at least one of the valve lift of the intake valve and the valve operating angle of the intake valve in the first characteristic.

5. (canceled)

6. (canceled)

7. The hybrid vehicle according to claim 1, wherein
when a process of starting up the internal combustion engine is executed, the controller is configured to control the variable valve actuating device such that at least one of the valve lift of the intake valve and the valve operating angle of the intake valve when the performance of the electrical storage device is in the second state is smaller than the corresponding at least one of the valve lift of the intake valve and the valve operating angle of the intake valve when the performance of the electrical storage device is in the first state.

8. (canceled)

9. The hybrid vehicle according to claim 1, wherein
when the internal combustion engine is in a cold state, the controller is configured to control the variable valve actuating device such that at least one of the valve lift of the intake valve and the valve operating angle of the intake valve at start-up of the internal combustion engine when the performance of the electrical storage device is in the second state is smaller than the corresponding at least one of the valve lift of the intake valve and the valve operating angle of the intake valve at start-up of the internal combustion engine when the performance of the electrical storage device is in the first state.

10. The hybrid vehicle according to claim 1, further comprising:
a power transmission gear through which the rotary electric machine is mechanically coupled to both an output shaft of the internal combustion engine and a drive shaft of the hybrid vehicle.

11. A controller for a hybrid vehicle, the hybrid vehicle including an internal combustion engine, a rotary electric machine, and an electrical storage device,
the internal combustion engine including a variable valve actuating device configured to change an operation characteristic of an intake valve,
the rotary electric machine being configured to start up the internal combustion engine, and
the electrical storage device being configured to store electric power for driving the rotary electric machine,
the controller comprising:
first control means for starting up the internal combustion engine; and
second control means for controlling the variable valve actuating device such that at least one of a valve lift of the intake valve and a valve operating angle of the intake valve at start-up of the internal combustion engine when performance of the electrical storage device is in a second state is smaller than the corresponding at least one of the valve lift of the intake valve and the valve operating angle of the intake valve at start-up of the internal combustion engine when the performance of the electrical storage device is in a first state, the performance of the electrical storage device in the second state being more limited than the performance of the electrical storage device in the first state, wherein
when a process of stopping the internal combustion engine is executed, the second control means is configured to control the variable valve actuating device such that at least one of the valve lift of the intake valve and the valve operating angle of the intake valve when the performance of the electrical storage device is in the second state is smaller than the corresponding at least one of the valve lift of the intake valve and the valve operating angle of the intake valve when the performance of the electrical storage device is in the first state.

12. A control method for a hybrid vehicle, the hybrid vehicle including an internal combustion engine, a rotary electric machine, an electrical storage device, and a controller,
the internal combustion engine including a variable valve actuating device configured to change an operation characteristic of an intake valve,
the rotary electric machine being configured to start up the internal combustion engine,
the electrical storage device being configured to store electric power for driving the rotary electric machine,
the control method comprising:
(A) starting up the internal combustion engine by the controller;
(B) controlling the variable valve actuating device by the controller such that at least one of a valve lift of the intake valve and a valve operating angle of the intake valve at start-up of the internal combustion engine when performance of the electrical storage device is in a second state is smaller than the corresponding at least one of the valve lift of the intake valve and the valve operating angle of the intake valve at start-up of the internal combustion engine when the performance of the electrical storage device in is a first state, the performance of the electrical storage device in the second state being more limited than the performance of the electrical storage device in the first state; and
(C) when a process of stopping the internal combustion engine is executed, controlling the variable valve actuating device by the controller such that at least one of the valve lift of the intake valve and the valve operating angle of the intake valve when the performance of the electrical storage device is in the second state is smaller than the corresponding at least one of the valve lift of the intake valve and the valve operating angle of the intake valve when the performance of the electrical storage device is in the first state.

13. A hybrid vehicle comprising:
an internal combustion engine including a variable valve actuating device configured to change an operation characteristic of an intake valve;
a rotary electric machine configured to start up the internal combustion engine;
an electrical storage device configured to store electric power for driving the rotary electric machine; and
a controller configured to control the variable valve actuating device such that at least one of a valve lift of the intake valve and a valve operating angle of the intake valve at start-up of the internal combustion engine when performance of the electrical storage device in a second state is smaller than the corresponding at least one of the valve lift of the intake valve and the valve operating angle of the intake valve at start-up of the internal combustion engine when the performance of the electrical storage device is in a first state, the performance of the electrical storage device in the second state being more limited than the performance of the electrical storage device in the first state, wherein
the variable valve actuating device is configured to change the operation characteristic of the intake valve to any one of a first characteristic, a second characteristic and a third characteristic,
when the performance of the electrical storage device is in the second state, the controller is configured to control the variable valve actuating device such that the operation characteristic of the intake valve at start-up of the internal combustion engine is set to one of the first characteristic and the second characteristic, and
when the performance of the electrical storage device is in the first state, the controller is configured to control the variable valve actuating device such that the operation characteristic of the intake valve at start-up of the internal combustion engine is set to the third characteristic, at least one of the valve lift of the intake valve and the valve operating angle of the intake valve in the second characteristic is larger than the corresponding at least one of the valve lift of the intake valve and the valve operating angle of the intake valve in the first characteristic, and at least one of the valve lift of the intake valve and the valve operating angle of the intake valve in the third characteristic is larger than the corresponding at least one of the valve lift of the intake valve and the valve operating angle of the intake valve in the second characteristic.

14. A hybrid vehicle comprising:
an internal combustion engine including a variable valve actuating device configured to change an operation characteristic of an intake valve;
a rotary electric machine configured to start up the internal combustion engine;
an electrical storage device configured to store electric power for driving the rotary electric machine; and
a controller configured to control the variable valve actuating device such that at least one of a valve lift of the intake valve and a valve operating angle of the intake valve at start-up of the internal combustion engine when performance of the electrical storage device is in a second state is smaller than the corresponding at least one of the valve lift of the intake valve and the valve operating angle of the intake valve at start-up of the internal combustion engine when the performance of the electrical storage device is in a first state, the performance of the electrical storage device in the second state being more limited than the performance of the electrical storage device in the first state, wherein
when the internal combustion engine is in a warm state, the controller is configured to control the variable valve actuating device such that at least one of the valve lift of the intake valve and the valve operating angle of the intake valve at start-up of the internal combustion engine when the performance of the electrical storage device is in the second state is equal to the corresponding at least one of the valve lift of the intake valve and the valve operating angle of the intake valve at start-up of the internal combustion engine when the performance of the electrical storage device is in the first state.
